(19) United States
(12) Patent Application Publication
(10) Pub. No.: US 2014/0091905 A1
(43) Pub. Date: Apr. 3, 2014

(54) METHOD, APPARATUS, AND SYSTEM FOR PASSWORD CONTROL

(71) Applicant: Huawei Device CO.,Ltd., Shenzhen (CN)

(72) Inventor: Zejiang Wang, Shenzhen (CN)

(73) Assignee: Huawei Device CO.,Ltd., Shenzhen (CN)

(21) Appl. No.: 13/796,028

(22) Filed: Mar. 12, 2013

(30) Foreign Application Priority Data
Mar. 15, 2012 (CN) 201210068944.3

(51) Int. Cl. G05B 1/01

(52) U.S. Cl. CPC G05B 1/01
USPC 340/5.54

(57) ABSTRACT

Embodiments of the present invention provide a method, an apparatus, and a system for password control, and relate to the field of password technologies. The method includes: receiving, by a combination lock, an unlock password that is sent by a mobile terminal through a network; matching, by the combination lock, the unlock password with an unlock password preset for the mobile terminal; when the unlock password matches the unlock password preset for the mobile terminal, executing, by the combination lock, an unlock operation. Embodiments of the present invention enhance the security of entering passwords.

### CROSS-REFERENCE TO RELATED APPLICATIONS

This application claims priority to Chinese Patent Application No. 201210068944.3, filed on Mar. 15, 2012, which is hereby incorporated by reference in its entirety.

### FIELD OF THE INVENTION

The present invention relates to the field of password technologies, and in particular, to a method, an apparatus, and a system for password control.

### BACKGROUND OF THE INVENTION

At present, commonly used combination lock systems include a mechanical combination lock, an electronic combination lock, and a fingerprint combination lock. When a user uses these combination lock systems, the user enters a password by using an external keyboard or a fingerprint collector; after an information processing unit in a combination lock system receives the entered password, the information processing unit matches the entered password with a preset password; if the entered password matches the preset password, the information processing unit performs unlock processing.

However, password input apparatuses adopted by the combination lock systems in the prior art, for example, external keyboards or fingerprint collectors, have the following problems: Most of the apparatuses are exposed, so that passwords are easily peeped; after the apparatuses are used, there are tracks, which are easily recorded and cracked; so the security of entering passwords is relatively low.

### SUMMARY OF THE INVENTION

Embodiments of the present invention provide a method, an apparatus, and a system for password control to enhance the security of entering passwords.

To achieve the preceding objectives, embodiments of the present invention use the following technical solutions:

In one aspect, a method for password control is provided, including:

receiving, by a combination lock, an unlock password that is sent by a mobile terminal through a network;

matching, by the combination lock, the unlock password with an unlock password preset for the mobile terminal; and

when the unlock password matches the unlock password preset for the mobile terminal, executing, by the combination lock, an unlock operation.

In another aspect, a method for password control is provided, including:

receiving, by a mobile terminal, an unlock password entered by a user; and

sending, by the mobile terminal, the unlock password to a combination lock through a network.

In another aspect, a combination lock is further provided, including:

a network module, configured to receive an unlock password that is sent by a mobile terminal through a network;

a matching module, configured to match the unlock password with an unlock password preset for the mobile terminal; and

a controlling module, configured to execute an unlock operation when the unlock password matches the unlock password preset for the mobile terminal.

In another aspect, a mobile terminal is further provided, including:

an input module, configured to receive an unlock password entered by a user; and

a sending module, configured to send the unlock password to a combination lock through a network.

In another aspect, a combination lock system is further provided, including the foregoing combination lock and the foregoing mobile terminal.

According to the foregoing technical solutions in embodiments of the present invention, a user enters an unlock password through a mobile terminal, and the mobile terminal sends the unlock password to a combination lock through a network, so as to implement an unlock operation. The mobile terminal acts as a password input apparatus and is independent of the combination lock. In addition, the mobile terminal is exclusively owned by a user and is not easily peeped, and can be always carried by the user. Embodiments of the present invention enhance the security of entering passwords when compared with the password input apparatuses adopted by combination lock systems in prior art that have the following problems: Most of the apparatuses are exposed, so that passwords are easily peeped; after the apparatuses are used, there are tracks, which are easily recorded and cracked, resulting in the relatively low security of entering passwords.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following descriptions merely show some embodiments of the present invention, and persons of ordinary skill in the art may still derive other drawings from the accompanying drawings without creative efforts.

FIG. 1 is a flowchart of a method for password control according to an embodiment of the present invention;

FIG. 2 is a flowchart of another method for password control according to an embodiment of the present invention;

FIG. 3 is a flowchart of a method for password control according to another embodiment of the present invention;

FIG. 4 is a structural diagram of a combination lock according to an embodiment of the present invention;

FIG. 5 is a structural diagram of another combination lock according to an embodiment of the present invention;

FIG. 6 is a structural diagram of a mobile terminal according to an embodiment of the present invention; and

FIG. 7 is a structural diagram of a combination lock system according to an embodiment of the present invention.

### DETAILED DESCRIPTION OF THE EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

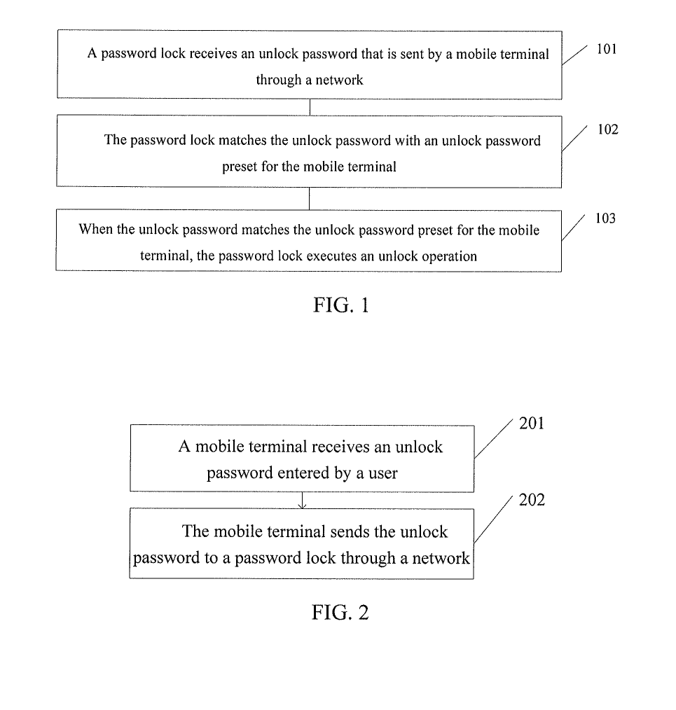

As shown in FIG. 1, an embodiment of the present invention provides a method for password control executed by a combination lock. The method includes the following:

101. A combination lock receives an unlock password that is sent by a mobile terminal through a network.

The network may be a wired network or a wireless network.

The unlock password may be formed by any type of numbers, letters, handwriting fonts, pictures, and fingerprints, or a combination of several types therein. The length of the unlock password may be set by a user according to actual needs, so as to reduce the easiness in cracking the password and enhance the security of the password. For details about the coding mode of the unlock password in the present invention, reference may be made to the password coding modes in prior art.

102. The combination lock matches the unlock password with an unlock password preset for the mobile terminal.

103. When the unlock password matches the unlock password preset for the mobile terminal, the combination lock executes an unlock operation.

Accordingly, as shown in FIG. 2, an embodiment of the present invention provides a method for password control, including the following:

201. A mobile terminal receives an unlock password entered by a user.

The unlock password may be formed by any type of numbers, letters, handwriting fonts, pictures, and fingerprints, or a combination of several types therein. The length of the unlock password may be set by the user according to actual needs.

202. The mobile terminal sends the unlock password to a combination lock through a network.

The mobile terminal sends, by using its own WIFI module or Bluetooth module, the unlock password to the combination lock through a wireless network.

Or, the mobile terminal accesses a wired network interface provided by the combination lock, and sends the unlock password to the combination lock through a wired network.

According to the technical solutions in the embodiment of the present invention, a user enters an unlock password through a mobile terminal, and the mobile terminal sends the unlock password to a combination lock, so as to implement an unlock operation. The mobile terminal acts as a password input apparatus and is independent of the combination lock. In addition, the mobile terminal is exclusively owned by a user and is not easily peeped, and can be always carried by the user. The embodiment of the present invention enhances the security of entering passwords when compared with the password input apparatuses adopted by combination lock systems in prior art that have the following problems: Most of the apparatuses are exposed, so that passwords are easily peeped; after the apparatuses are used, there are tracks, which are easily recorded and cracked, resulting in the relatively low security of entering passwords.

It should be noted that, to further enhance the security of entering passwords, only a switch for starting the system of the combination lock and a camera may be arranged outside the combination lock, without arranging any password input area. When the switch is turned on, the system of the combination lock performs initialization, and the camera begins to work and collect monitored videos. Meanwhile, a wireless network is also enabled. Of course, a password input area may also be arranged outside the combination lock, so that when the mobile terminal carried by the user cannot work normally, the user can also enter an unlock password through the password input area, which is not specifically limited by the present invention.

In this embodiment, the network used when the combination lock performs data communication with the mobile terminal includes the following types:

1. Wired Network

The combination lock communicates with the mobile terminal through the wired network. Interfaces that the combination lock provides for the mobile terminal to use the wired network include a USB (universal serial bus, Universal Serial BUS) interface or a network cable interface.

Accordingly, when the user enters the password by using the mobile terminal, the user connects the mobile terminal to the wired network interface provided by the combination lock, so that the mobile terminal communicates with the combination lock through the wired network.

2. Wireless Network

The combination lock communicates with the mobile terminal through the wireless network. The combination lock includes the following modules configured to provide the wireless network: a WIFI (Wireless Fidelity, wireless fidelity) module or a Bluetooth module.

Accordingly, when the user enters the password by using the mobile terminal, the user enables a wireless network module of the mobile terminal, and communicates with the combination lock through the wireless network, where the wireless network module includes a WIFI module or a Bluetooth module.

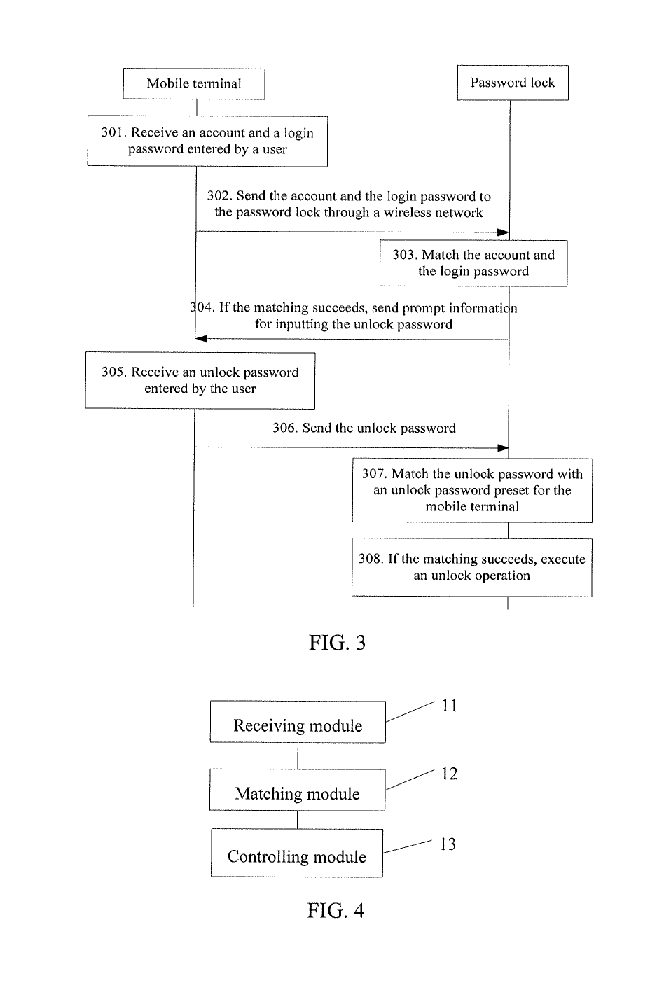

To make the present invention more comprehensible, the following provides another embodiment by taking an example that a combination lock communicates with a mobile terminal through a wireless network. The mobile terminal refers to a terminal that has a wireless network module and is able to perform wireless communication, where the wireless network module includes, but is not limited to, a WIFI module or a Bluetooth module. The mobile terminal includes a handset, an MP4 player, and a tablet computer. As shown in FIG. 3, the method includes the following:

301. The mobile terminal receives an account and a login password entered by a user.

In specific applications, the user enables a WIFI module on a handset to search for a wireless network provided by the combination lock, and prompt information for inputting an account and a login password may be displayed on the handset. At this time, after the user enters an account and a login password on the handset, the handset can receive the account and the login password entered by the user.

302. The mobile terminal sends the account and the login password to the combination lock through the wireless network.

For example, the mobile terminal sends, by using a pre-allocated network address, the account and the login password to the combination lock through the wireless network.

The network address is pre-allocated by the combination lock to the mobile terminal. The mobile terminal may log in successfully by using the network address that is pre-allocated by the combination lock to the mobile terminal. The mobile terminal cannot log in when using an address other than the pre-allocated network address, for example, a dynamically allocated address. Therefore, a new protection layer is added for entering the unlock password subsequently, which can further ensure the security of entering the unlock password.

It should be noted that in the embodiment of the present invention, the account and login password are pre-allocated by the combination lock, which makes it convenient to control the security of the account. Compared with the prior art where the user obtains the account and login password through application and registration, this embodiment further guarantees the security of logging in to the combination lock. Of course, in the present invention, the user may also obtain the account and login password through application and registration, which is not limited herein.

303. After receiving the account and the login password that are sent by the mobile terminal through the wireless network, the combination lock performs matching for the account and the login password.

304. When the account and the login password match an account and a login password pre-allocated by the combination lock to the mobile terminal, the combination lock sends prompt information for inputting the unlock password to the mobile terminal.

305. After receiving prompt information for inputting the unlock password sent by the combination lock, the mobile terminal receives an unlock password entered by the user.

Specifically, when the mobile terminal receives prompt information for inputting the unlock password, it may display the prompt information by using a real-time password input interface of a combination lock system, or by using a short message, or by other ways.

The unlock password may be formed by any type of numbers, letters, handwriting fonts, pictures, and fingerprints, or a combination of several types therein. The length of the unlock password may be set by the user according to actual needs.

306. The mobile terminal sends the unlock password to the combination lock through the wireless network.

For example, the mobile terminal sends, by using its own WIFI module or Bluetooth module, the unlock password to the combination lock through the wireless network.

307. After receiving the unlock password that is sent by the mobile terminal through the wireless network, the combination lock matches the unlock password with an unlock password preset for the mobile terminal.

308. When the unlock password matches the unlock password preset for the mobile terminal, the combination lock executes an unlock operation. For example, the combination lock may control a relay to execute the unlock operation.

After the user opens a combination lock and finishes an operation, a lock door is closed, and the system of the combination lock is closed by using a switch outside the combination lock.

It should be noted that performing matching for the account and the login password in the step 303 is specifically as follows: When the account and the login password do not match an account and a login password pre-allocated by the combination lock to the mobile terminal, an error tolerance counter in the combination lock begins to count. When the count of the error tolerance counter in the combination lock reaches a preset threshold, the combination lock closes its own system, and disconnects the wireless network.

The matching the unlock password in step 307 is specifically as follows: When the unlock password does not match an unlock password preset for the mobile terminal, the error tolerance counter in the combination lock begins to count. When the count of the error tolerance counter in the combination lock reaches a preset threshold, the combination lock closes its own system, and disconnects the wireless network.

Accordingly, as shown in FIG. 4, another embodiment of the present invention provides a combination lock, including:

a receiving module 11, configured to receive an unlock password that is sent by a mobile terminal through a network;

a matching module 12, configured to match the unlock password with an unlock password preset for the mobile terminal; and

a controlling module 13, configured to execute an unlock operation when the unlock password matches the unlock password preset for the mobile terminal.

In this embodiment, the combination lock receives an unlock password from the mobile terminal, so as to implement the unlock operation. The mobile terminal acts as a password input apparatus and is independent of the combination lock. In addition, the mobile terminal is exclusively owned by a user and is not easily peeped, and can be always carried by the user. The embodiment of the present invention enhances the security of entering passwords when compared with the password input apparatuses adopted by combination lock systems in prior art that have the following problems: Most of the apparatuses are exposed, so that passwords are easily peeped; after the apparatuses are used, there are tracks, which are easily recorded and cracked, resulting in the relatively low security of entering passwords.

Specifically, before the combination lock receives the unlock password that is sent by the mobile terminal through the network, the receiving module 11 is further configured to receive an account and a login password sent by the mobile terminal through the network.

The controlling module 13 is further configured to send prompt information for inputting the unlock password to the mobile terminal when the account and the login password match the account and the login password pre-allocated by the combination lock to the mobile terminal.

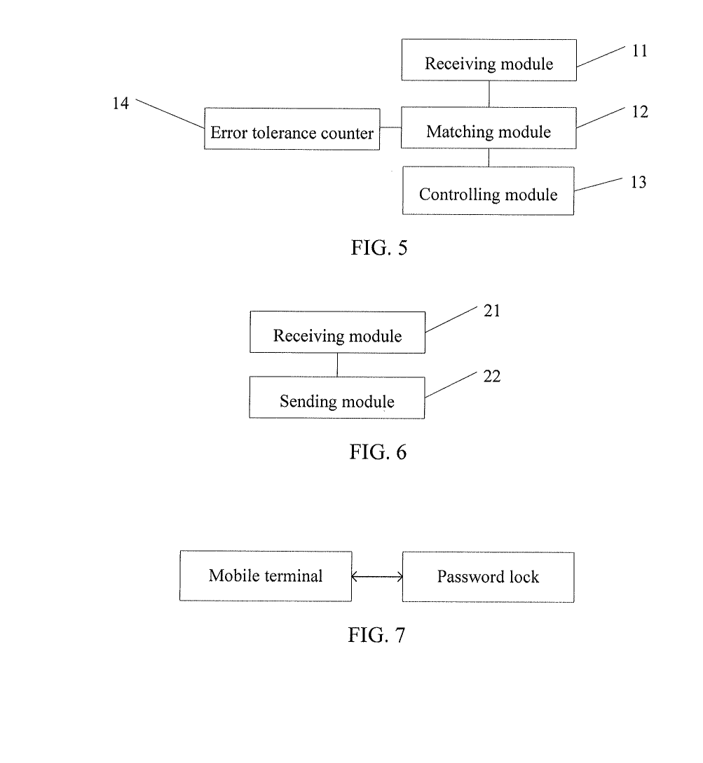

As shown in FIG. 5, the combination lock further includes:

an error tolerance counter 14, configured to: when the unlock password does not match the unlock password preset for the mobile terminal or when the account and the login password do not match the account and the login password pre-allocated by the combination lock to the mobile terminal, begin to count; where

the controlling module is further configured to: when the count of the error tolerance counter in the combination lock reaches a preset threshold, close a system of the combination lock, and disconnect the network.

Optionally, the combination lock further includes: a wired network interface module, configured to communicate with the mobile terminal through a wired network, where the wired network interface module includes a USB interface or a network cable interface.

Optionally, the combination lock further includes: a wireless network module, configured to communicate with the mobile terminal through a wireless network, where the wireless network module includes a WIFI module or a Bluetooth module.

As shown in FIG. 6, another embodiment of the present invention further provides a mobile terminal, including:

a receiving module 21, configured to receive an unlock password entered by a user; and

a sending module 22, configured to send the unlock password to a combination lock through a network.

In this embodiment, a user enters an unlock password through a mobile terminal, and the mobile terminal sends the unlock password to a combination lock, so as to implement an unlock operation. The mobile terminal acts as a password input apparatus and is independent of the combination lock. In addition, the mobile terminal is exclusively owned by a user and is not easily peeped, and can be always carried by the user. The embodiment of the present invention enhances the security of entering passwords when compared with the password input apparatuses adopted by combination lock systems in prior art that have the following problems: Most of the apparatuses are exposed, so that passwords are easily peeped; after the apparatuses are used, there are tracks, which are easily recorded and cracked, resulting in the relatively low security of entering passwords.

Specifically, before the mobile terminal sends the unlock password to the combination lock through the network, the receiving module 21 is further configured to receive an account and a login password entered by the user.

The sending module 22 is further configured to send the account and the login password to the combination lock through a wireless network, where the account and the login password are pre-allocated by the combination lock to the mobile terminal.

The receiving module 21 is further configured to receive prompt information for inputting the unlock password sent by the combination lock.

Optionally, the mobile terminal further includes: a wired network interface module adaptable to wired network interfaces provided by the combination lock, configured to communicate with the combination lock through a wired network, where the wired network interface module includes a USB interface or a network cable interface.

Optionally, the mobile terminal further includes: a wireless network module, configured to communicate with the combination lock through a wireless network, where the wireless network module includes a WIFI module or a Bluetooth module.

As shown in FIG. 7, an embodiment of the present invention further provides a combination lock system, including the combination lock illustrated in FIG. 4 or FIG. 5 and the mobile terminal illustrated in FIG. 6.

The foregoing descriptions are merely specific embodiments of the present invention, but are not intended to limit the protection scope of the present invention. Any variation or replacement readily figured out by persons skilled in the art within the technical scope disclosed in the present invention shall all fall within the protection scope of the present invention. Therefore, the protection scope of the present invention shall be subject to the protection scope of the claims.

What is claimed is:

1. A method for password control, comprising:
receiving, by a combination lock, an unlock password that is sent by a mobile terminal through a network;
matching, by the combination lock, the unlock password with an unlock password preset for the mobile terminal; and
when the unlock password matches the unlock password preset for the mobile terminal, executing, by the password, an unlock operation.

2. The method according to claim 1, wherein before the combination lock receives the unlock password that is sent by the mobile terminal through the network, the method further comprises:
receiving, by the combination lock, an account and a login password sent by the mobile terminal through the network; and
when the account and the login password match an account and a login password pre-allocated to the mobile terminal, sending, by the combination lock, prompt information for inputting the unlock password to the mobile terminal.

3. The method according to claim 1, wherein the network comprises:
a wired network, wherein interfaces that the combination lock provides for the mobile terminal to use the wired network comprise a universal serial bus USB interface or a network cable interface;
or
a wireless network, wherein the combination lock comprises the following modules configured to provide the wireless network: a wireless fidelity WIFI module or a Bluetooth module.

4. The method according to of claim 1, further comprising:
when the unlock password does not match the unlock password preset for the mobile terminal, counting by an error tolerance counter in the combination lock; and
when a count of the error tolerance counter in the combination lock reaches a preset threshold, closing, by the combination lock, a system of the combination lock, and disconnecting the network.

5. The method according to claim 2, further comprising:
when the unlock password does not match the unlock password preset for the mobile terminal or when the account and the login password do not match the account and the login password pre-allocated to the mobile terminal, counting, by an error tolerance counter in the combination lock; and
when a count of the error tolerance counter in the combination lock reaches a preset threshold, closing, by the combination lock, a system of the combination lock, and disconnecting the network.

6. A method for password control, comprising:
receiving, by a mobile terminal, an unlock password entered by a user; and
sending, by the mobile terminal, the unlock password to a combination lock through a network.

7. The method according to claim 6, wherein before the mobile terminal sends the unlock password to the combination lock through the network, the method further comprises:
receiving, by the mobile terminal, an account and a login password entered by the user;
sending, by the mobile terminal, the account and the login password to the combination lock through the network, wherein the account and the login password are pre-allocated by the combination lock to the mobile terminal; and
receiving, by the mobile terminal, prompt information for inputting the unlock password sent by the combination lock.

8. The method according to claim 6, wherein the network comprises:
a wired network, wherein interfaces used by the mobile terminal to access the wired network comprise a universal serial bus USB interface or a network cable interface; or
a wireless network, wherein the mobile terminal comprises the following modules configured to access the wireless network: a wireless fidelity WIFI module or a Bluetooth module.

9. A combination lock, comprising:
a receiving module, configured to receive an unlock password that is sent by a mobile terminal through a network;
a matching module, configured to match the unlock password with an unlock password preset for the mobile terminal; and
a controlling module, configured to execute an unlock operation when the unlock password matches the unlock password preset for the mobile terminal.

10. The combination lock according to claim 9, wherein:
the receiving module is further configured to receive an account and a login password sent by the mobile terminal through the network; and
the controlling module is further configured to send prompt information for inputting the unlock password to the mobile terminal when the account and the login password match the account and the login password pre-allocated to the mobile terminal.

11. The combination lock according to claim 9, further comprising:
a wired network interface module, configured to communicate with the mobile terminal through a wired network, wherein the wireless network interface module comprises a universal serial bus USB interface or a network cable interface;
or
a wireless network module, configured to communicate with the mobile terminal through a wireless network, wherein the wireless network module comprises a wireless fidelity WIFI module or a Bluetooth module.

12. The combination lock according to claim 9, further comprising:
an error tolerance counter, configured to: when the unlock password does not match the unlock password preset for the mobile terminal, perform counting; wherein
the controlling module is further configured to: when a count of the error tolerance counter reaches a preset threshold, close a system of the combination lock, and disconnect the network.

13. The combination lock according to claim 10, further comprising:
an error tolerance counter, configured to: when the unlock password does not match the unlock password preset for the mobile terminal or when the account and the login password do not match the account and the login password pre-allocated by the combination lock to the mobile terminal, perform counting; wherein
the controlling module is further configured to: when a count of the error tolerance counter reaches a preset threshold, close a system of the combination lock, and disconnect the network.

14. A mobile terminal, comprising:
a receiving module, configured to receive an unlock password entered by a user; and
a sending module, configured to send the unlock password to a combination lock through a network.

15. The mobile terminal according to claim 14, wherein:
the receiving module is further configured to receive an account and a login password entered by the user;
the sending module is further configured to send the account and the login password to the combination lock through the network, where the account and the login password are pre-allocated by the combination lock to the mobile terminal; and
the receiving module is further configured to receive prompt information for inputting the unlock password sent by the combination lock.

16. The mobile terminal according to claim 14, further comprising:
a wired network interface module adaptable to wired network interfaces provided by the combination lock, configured to communicate with the combination lock through a wired network, wherein the wired network interface module comprises a universal serial bus USB interface or a network cable interface; or
a wireless network module, configured to communicate with the mobile terminal through a wireless network, wherein the wireless network module comprises a wireless fidelity WIFI module or a Bluetooth module.
